(19) United States
(12) Patent Application Publication
(10) Pub. No.: US 2014/0319977 A1
(43) Pub. Date: Oct. 30, 2014

(54) GENERATOR OF A GEARLESS WIND TURBINE

(71) Applicant: Wobben Properties GmbH, Aurich (DE)

(72) Inventor: Wojciech Giengiel, Aurich (DE)

(21) Appl. No.: 14/367,175

(22) PCT Filed: Dec. 14, 2012
(86) PCT No.: PCT/EP2012/075579

§ 371 Date: Jun. 19, 2014

(30) Foreign Application Priority Data
Dec. 21, 2011 (DE) 10 2011 089 498.5

(51) Int. Cl. H02K 11/04

(52) U.S. Cl. CPC H02K 11/046
USPC 310/68 D

(57) ABSTRACT

The invention relates to a generator of a gearless wind turbine, having a stator and a rotor, and comprising stator windings for generating several alternating currents, in particular at least three alternating currents phase-shifted from each other, rectifying means for rectifying the alternating currents, and at least two direct-current bus bars for collecting the rectified alternating currents.

### BACKGROUND

1. Technical Field

The present invention concerns a generator of a gearless wind power installation as well as a rectifier and a wind power installation.

2. Description of the Related Art

Wind power installations are generally known. They convert energy from the wind into electric energy. An aerodynamic rotor is driven by the wind, which in turn drives an electric generator. A distinction can be drawn inter alia between two general types of wind power installations, namely those in which there is a gear transmission between the aerodynamic rotor and the generator, and those which operate in gearless fashion.

Gearless wind power installations are distinguished in that they use a slowly rotating, multi-pole generator, in particular a ring generator, which due to the principle involved is thus also of a large diameter, in particular with a large air gap diameter. Modern gearless wind power installations can nowadays involve an air gap diameter of up to 10 m. At least air gap diameters of about 4.5 m are nowadays entirely usual. The present invention also concerns in particular such generators.

In operation such generators usually involve at least a three-phase AC system, frequently two three-phase systems are used. If the coils or winding portions of each phase are respectively connected in series, the winding of each phase will typically carry the entire current of that phase. Accordingly thick conductors or conductor strands are to be provided to be able to carry that current. To avoid this, the winding of each phase can be divided into winding portions which are connected in mutually parallel relationship. That has the advantage that it is possible to use preformed coils whereby in particular the filling factor can be increased. Such winding portions are accordingly distributed over the entire periphery of the generator and the parallel circuitry can be implemented by way of a peripherally extending busbar for each phase. That peripherally extending busbar then collects the current of the phase. The current of such a busbar then substantially corresponds to the current which occurs in the winding line of the variant in which all winding portions of a phase are connected in series. Those currents can then basically be used in both variants in the same fashion for further processing, namely the feed into an electric network, insofar as they are rectified with a rectifier and are thus prepared for an inverter for the feed into the network.

The parallel circuitry of a plurality of winding portions admittedly permits respective winding lines of smaller cross-section than in the case of the series connection, but the use of the busbars can also give rise to problems. In particular two three-phase systems typically use six busbars. Those busbars can be combined in the form of six circular rings with suitable insulation therebetween to give an approximately cylindrical busbar body which however can assume outside dimensions that raise problems in terms of the space needed. In particular they can impede or cause difficulties with fixing the generator, namely the stator of the generator.

The German Patent and Trade Mark Office searched the following state of the art in the priority application in respect of the present application: DE 197 29 034 A1. DE 20 52 808 A, U.S. Pat. No. 6,894,411 B2, US 2009/0212568 A1, US 2010/0072834 A1, EP 2 472 714 A1 and WO 2006/100420 A1.

### BRIEF SUMMARY

One or more embodiments of the present invention is directed to a generator of a gearless wind power installation in respect of current distribution of the generated current, and in particular also to propose a solution involving the minimum possible space requirement. At least the invention seeks to find an alternative solution.

According to one embodiment of the invention there is proposed a generator according to claim 1. In accordance therewith the generator has a stator and a rotor member. The stator carries stator windings for generating a plurality of alternating currents, in particular at least three mutually phase-displaced alternating currents. There are also provided a rectifier for rectifying the alternating currents. The rectifying means are thus part of the generator. Direct current collecting lines, in particular direct current busbars, for collecting the alternating currents rectified to give direct current, are provided on the stator or immediately adjacent thereto. The direct current busbars are also thus part of the generator and the rectifying means are disposed between the stator windings and the busbars, in particular being interconnected therewith, and also locally arranged there. The direct current busbars thus receive all the generated and rectified currents. Particularly when there are only two direct current busbars, namely one for positive potential and one for negative potential, the entire rectified current flows by way of each direct current busbar. For that reason the direct current collecting lines are desirably in the form of direct current busbars. A fixed local arrangement on the stator is also desirably to be implemented with a bar, in which case a different kind of direct current collecting line is not out of the question.

The solution thus provides that the generated alternating currents are already rectified at the generator, namely at the stator, and it is only the rectified currents which are added to give a correspondingly large direct current, that are passed on from the location at which they are produced. Here in particular the basic notion is that the generators of a gearless wind power installation are of a large local extent. In the case of a generator of a diameter of 5 m, this gives a periphery of over 15 m, along which a part of the currents has to be passed, with the corresponding lines. Even in the case of a three-phase current at least three lines would have to be provided for that purpose. In the case of a six-phase system even six lines are to be provided, which depending on the current value could also be provided in the form of busbars. Rectification on site means that only two direct current busbars still have to be provided.

In addition it is possible to save on a separate rectifier if rectification is effected directed at the generator. The rectifying means of the generator can be respectively formed at least from one pair of diodes or at least one pair of thyristors, in which case a respective diode or thyristor is arranged between an alternating current terminal of the stator windings and a direct current busbar, and a further diode or a further thyristor is arranged between that alternating current terminal and the second direct current busbar. Rectification is basically effected in known manner using known rectifying means which in that respect are adapted in particular in dimensions to the specific structure of that generator.

In an embodiment the generator is in the form of a synchronous generator, in particular a separately excited synchronous generator, and in that respect preferably in the form of an external rotor member. In the case of a synchronous generator a rotor member rotates with a fixed magnetic field which in the case of the separately excited synchronous generator is produced by corresponding direct currents or a corresponding direct current as the exciter current, and, due to the rotary movement, the rotor member generates in the stator and thus in the stator windings a corresponding rotary field and thereby the plurality of alternating currents. In the configuration in the form of an external rotor member the stator is disposed inwardly relative to the rotor member, whereby a great deal of space remains for the configuration of the stator in an inward direction. Accordingly there is space for arranging the rectifying means and the direct current busbars and also space for providing a cooling system which can possibly also be used for cooling the rectifying means.

In an embodiment, the busbars are of an annular configuration and extend approximately along the stator and/or the rectifying means and/or the direct current connecting lines, in particular direct current busbars, are fixed to the generator, in particular the stator, in particular in such a way that they are cooled together with the generator. The direct current busbars are disposed in relation to or at the stator or a cooling device and/or a cooling body of the stator or the generator, in such a way that the cooling provided for the generator also acts for the direct current busbars and/or the rectifying means. In particular the arrangement is so selected that an air flow for cooling the generator also provides the cooling action for the direct current busbars and/or the rectifying means. In that way the stator can perform cooling in particular for the rectifying means.

In an embodiment it is proposed that the alternating currents form a system having at least three phases, that is to say a three-phase system, in particular a six-phase system. In that respect a six-phase system is in particular a system comprising two three-phase systems. The phases of a three-phase system are displaced relative to each other through 120° and two three-phase systems are displaced relative to each other through about 30° so that there are then six phases of which two adjacent ones are respectively displaced through 30° . The stator windings each have a respective phase winding for each phase.

The phase windings are preferably subdivided into phase winding portions. Thus, for the example of six phases, there is basically a set of stator windings, namely the totality of all windings of the stator, six phase windings and overall for the entire stator at least 12 phase winding portions, namely at least two for each phase for the specified example.

Each phase winding portion is connected to at least two busbars by way of one of the rectifying means. Thus rectification is implemented for each phase winding portion and the respective alternating current of the phase winding portion is fed in rectified form as a direct current on to the two busbars. In the above example therefore there would be provided at least 12 rectifying means and accordingly direct current would be passed into the busbars at 12 locations distributed over the generator.

In particular three phases are respectively connected by way of a common star point. In the foregoing example with six phases and six phase windings and 12 phase winding portions, six phase winding portions would respectively have a common star point. Accordingly there are two common star points, namely one for each of the two three-phase systems.

Thus it is possible to provide for a parallel connection of phase winding portions, which manages with two direct current busbars for the entire generator. By virtue of the basically usual interconnection at the star point, only one connecting point per respective phase winding portion needs to be taken into consideration in regard to rectification.

It is desirable if there are provided at least six rectifying means, preferably at least 12, at least 24 or at least 48 rectifying means, distributed in the peripheral direction over the generator. In that respect it is desirable to use a multiple of the number of phases as the number of rectifying means so that a plurality of rectifying means are respectively provided for each phase, more specifically in particular there are also a corresponding number of phase winding portions. It is basically advantageous to provide many rectifying means which can then each be of correspondingly small size. Thus on the one hand a heat source is divided into many small heat sources so that the heat source is spatially distributed. On the other hand smaller semiconductor components like diodes or thyristors basically rather form a mass-produced item and are thus available inexpensively and in tried-and-tested manner, than if the semiconductor components are of a particularly large configuration. In addition finally it is possible to avoid a specific housing for the rectifying means. More specifically, this variant makes it possible to avoid a compact rectifier which rectifies the entire current of the generator. Such a separate rectifier can be large, and may use semiconductor components designed for the correspondingly high current and the cooling necessary for same. Instead it is proposed that the alternating currents are rectified directly where they are produced and they are thus rectified before they are added together to give a high alternating current.

Preferably the generator has a nominal power of at least 500 kW, at least 1 MW, in particular at least 2 MW. That emphasizes that a large modern generator is used, in which the above-mentioned problems can play a large part. In particular a large generator of that kind, for further processing of the current generated, also may use a correspondingly large rectifier which represents a special and thus expensive and heat-producing device. Accordingly, it is possible to save on a corresponding switching cabinet for the rectifier even in the pod of a wind power installation.

In a further embodiment it is proposed that the generator is in the form of a slowly rotating generator and/or a multi-pole generator having at least 48, at least 72, at least 96, in particular at least 192 stator poles and/or is in the form of a three-phase or six-phase generator. Particularly with such multi-pole generators the proposed solution can be efficiently used because here many rectifying means can be distributed over the generator in order to respectively rectify a small part of the current of the power generated. In principle it is also possible to use a known three-phase or six-phase generator which is modified by the provision of the rectifying means and the direct current busbars.

In addition according to one embodiment of the invention there is also proposed a ring rectifier for rectifying a plurality of alternating currents generated by a generator. Such a ring rectifier includes at least three rectifying means for rectifying a respective one of the generated alternating currents, and it includes at least two direct current collecting lines, in particular direct current busbars which are arranged in a ring form and which are adapted in their size to the generator for receiving the rectified alternating currents. In particular the ring rectifier is of a configuration like the two busbars described hereinbefore together with the rectifying means, wherein the rectifying means are adapted to be respectively connected to a phase winding or phase winding portion in order there to receive and rectify the generated alternating current. The ring rectifier is in particular adapted to be so connected to a generator that the ring rectifier and the generator together form a new generator, namely as was described in at least one of the foregoing embodiments.

Preferably the ring rectifier is comprised of rectifying means that are controlled and are connected to control lines for controlling the rectifying means. Such a configuration concerns in particular rectifying means formed from thyristors and/or insulated gate bipolar transistors (IGBT) which have to be actuated. Moreover such control lines can also be provided for the described generator in order to actuate the rectifying means there. Sometimes rectification can be improved by entirely or partially controlled rectifying means, for example in regard to losses at the corresponding semiconductor components. In addition it may sometimes be advantageous in terms of controlling the generator to act on the current taken from the generator and thus on the generator, by the rectifier, that is to say here by the rectifying means, in order possibly to partially control the generator.

There is further to be provided a wind power installation having a generator as described in at least one of the foregoing embodiments. It preferably has a ring rectifier as described above.

### BRIEF DESCRIPTION OF THE SEVERAL VIEWS OF THE DRAWINGS

The invention is described in greater detail hereinafter by means of embodiments by way of example with reference to the accompanying Figures.

FIG. 1 shows a perspective view of a wind power installation,

FIG. 2 diagrammatically shows a generator with rotor, stator, direct current busbars and rectifying means,

FIG. 3 diagrammatically shows a sectional view of a part of a ring generator with direct current busbars and rectifying means,

FIG. 4 shows an enlarged view of the direct current busbars with rectifying means of FIG. 3,

FIG. 5 shows a perspective view of a portion from two direct current busbars, and

FIG. 6 diagrammatically shows a portion of a generator according to the state of the art with six alternating current busbars.

### DETAILED DESCRIPTION

Hereinafter identical references can be used for similar but possibly non-identical elements or elements which are not identically illustrated because of the diagrammatic view. Different scales can be employed for identical or similar elements.

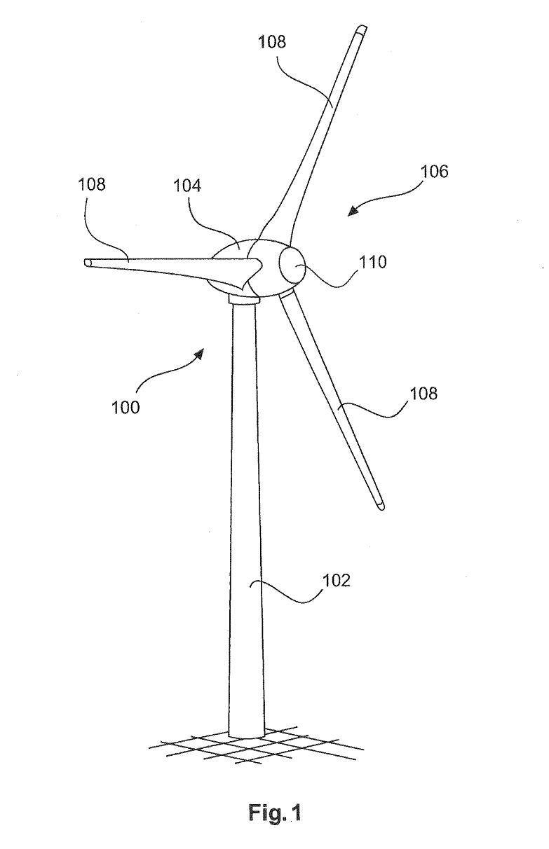

FIG. 1 shows a wind power installation 100 having a pylon 102 and a pod 104. A rotor 106 having three rotor blades 108 and a spinner 110 is arranged on the pod 104. In operation the rotor 106 is caused to rotate by the wind and thereby drives a generator in the pod 104.

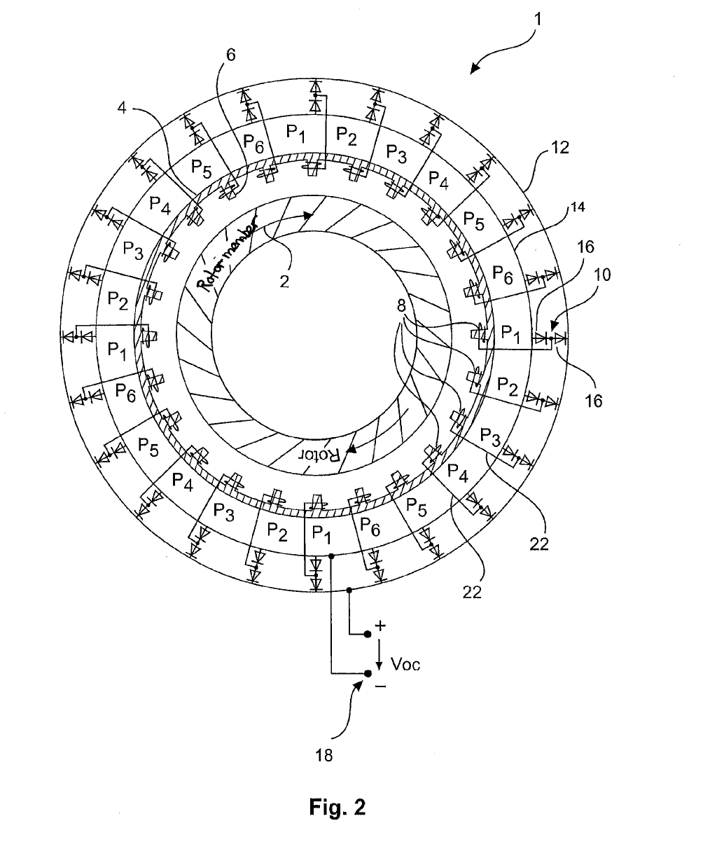

FIG. 2 diagrammatically shows a generator 1 with a rotor or rotor member 2 shown in highly simplified form and a stator 4. In normal operation the rotor member 2 rotates relative to the stator 4 which in normal operation is stationary at least in regard to the rotary movement of the rotor member. The diagrammatically illustrated stator 4 has 24 poles 6. The view with 24 poles is only selected for illustration purposes. Rather the generatoris preferably intended for substantially more poles. The spacing between the poles 6, which here is substantially greater than in a comparable actual system, is not an important consideration and is only a result of the diagrammatic view. Rather, FIG. 2 is intended to serve to illustrate the interconnection and the local distribution thereof over the periphery of the generator.

Referring to FIG. 2 each pole 6 has a phase winding portion 8. In the FIG. 2 view each phase winding portion 8 is associated with a pole 6. That however is only an illustrative example. Equally a phase winding portion 8 can be the series connection of windings of a plurality of stator poles.

In the illustrative example in FIG. 2 there are at any event a total of 24 phase winding portions 8, more specifically four respective ones for each phase. The phases are denoted by P₁ to P₆ in FIG. 2. Two adjacent phases are respectively displaced relative to each other through 30°. Thus there are two three-phase systems, namely a first three-phase system with the phases P₁, P₃ and P₅ and a second three-phase system with the phases P₂, P₄ and P₆. In this case the phases of a three-phase system, that is to say P₁, P₃ and P₅ on the one hand and P₂, P₄ and P₆ on the other hand, are respectively interconnected by way of a common star point which however is not shown in FIG. 2.

Each phase winding portion 8 is connected by way of a rectifying means 10 to two direct current busbars 12, 14, namely the positive direct current busbar 12 and the negative direct current busbar 14. Each rectifying means 10 has two diodes for rectification purposes. Here diodes are used as conventional rectifying elements, for illustration purposes. Instead of diodes it is also possible for example to use thyristors or IGBTs.

Thus in the present example 24 rectifying means 10 are distributed over the periphery of the generator 1, in particular over the periphery of the stator 4. In this example each phase is divided into four respective phase winding portions 8 and thus rectification is also effected for each phase at four different positions, more specifically approximately at 90° spacings distributed over the generator. In the illustrated example, therefore, 24 alternating currents are rectified by 24 rectifying means 10 and finally the resulting direct current portions are added in the form of a direct current or a positive and a negative direct current, occurring in the two direct current busbars 12 and 14. The two direct current busbars 12 and 14 thus carry all the electric power generated by the generator 1 and provide it at a direct current output 18 with a corresponding DC voltage V_{DC}. The rectifying means 10 which in the illustrated example only have to respectively rectify 1/24th of the power which is ultimately carried by the direct current busbars 12 and 14 can be of correspondingly small nature. Accordingly the use of comparable standard components can also be envisaged, which are inexpensive and tried-and-tested.

FIG. 2 shows the direct current busbars 12 and 14 of a differing diameter relative to each other and of a larger diameter in relation to the stator 4. The view in FIG. 2 however is only an illustration and preferably the stator 4, the positive direct current busbar 12 and the negative direct current busbar 14 are spaced relative to each other not radially but axially.

FIG. 3 shows a view in the peripheral direction of a portion of the generator 1. In this case the generator 1 has a rotor member 2 and a stator 4 with winding heads 20. A positive direct current busbar 12 and a negative direct current busbar 14 are shown on the stator 4 at the left-hand side in FIG. 3 and thus in the axial direction. The rectifying means 10 is arranged between those two direct current busbars 12, 14 and is interconnected by way of an alternating current connection 22 to a corresponding winding, in particular a phase winding portion, which however is not shown in greater detail in FIG. 3.

Thus the illustrated generator 1 operates in such a way that the rotor or rotor member 2 rotates relative to the stator 4, in which case there are generated in the stator 4 a plurality of alternating currents which are respectively rectified by way of rectifying means 10 and put on to the two direct current busbars 12, 14. There is thus provided a rotor 2 or rotor member 2 and a stator 4, there are also a positive direct current busbar 12 and a negative direct current busbar 14 but there are many rectifying means 10, of which only one is shown in FIG. 3.

In that respect FIG. 2 diagrammatically shows the distribution of such rectifying means 10 over the periphery of the generator 1. In addition the positive direct current busbar 12 with the negative direct current busbar 14 and the plurality of rectifying means 10 and finally the direct current connections 18 can be viewed as a ring rectifier. The alternating current connections 22 can partly be viewed as an element of such a ring rectifier. Accordingly, such a ring rectifier can be prepared separately from the rest of the generator 1 and upon assembly with the rest of the generator 1 only needs to be electrically connected at its alternating current connections 22 to the respective phase winding portions 8.

In this case the provision of direct current busbars 12, 14 can also provide a structure which is overall mechanically stable.

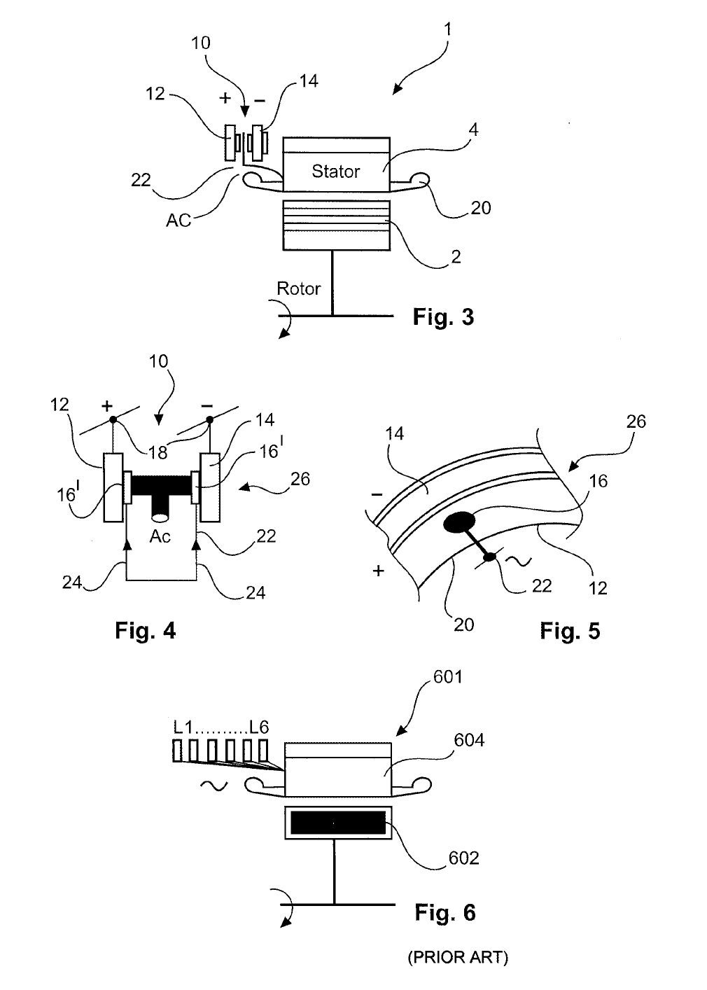

FIG. 4 shows a portion from FIG. 3, namely the positive direct current busbar 12, the negative direct current busbar 14, the rectifying means 10 of which the view in FIG. 4 shows only one, and the alternating current connections 22 of which FIG. 4 also shows only one, because of the illustrated view. The rectifying means 10 can have two thyristors 16′ as respective rectifying components. The alternating current connection 22 is arranged between two thyristors 16′. The thyristors 16′ can be actuated by way of control lines 24. When using IGBTs they would also have to be actuated, and that can be achieved by the actuating line 24 or suitably adapted actuating lines.

The portion from FIG. 3, that is shown in FIG. 4, thus illustrates a ring rectifier 26. When the latter is connected to the generator 1, in particular the stator 4, as is shown in FIG. 3, that ring rectifier 26 is part of the generator 4. In addition the direct current connections 18 are also diagrammatically indicated in FIG. 4.

FIG. 5 shows a perspective view of a portion of a ring rectifier 26. FIG. 5 shows the arrangement of the positive direct current busbar 12 in relation to the negative direct current busbar 14 which is disposed therebehind in FIG. 5. The rectifying means 10 with the alternating current connection 22 is shown for illustration purposes between those two direct current busbars 12, 14. Of the rectifying means 10, the Figure shows a thyristor 16′ in the form of a basically round component. Naturally, the positive direct current busbar 12 which is at the front in FIG. 5 would actually conceal that thyristor 16′ which is only shown here for illustration purposes.

Based on the perspective adopted in FIG. 3, FIG. 6 shows a generator 601 having a rotor member 602 and a stator 604. This arrangement also has a plurality of phase winding portions which are connected in phase-wise relationship to a respective alternating current bar L1 to L6, to provide the parallel circuit. The alternating current bars L1 to L6 are arranged to the left and thus in the axial direction from the stator 604 in the illustrated view. It will be seen that here there is a quite considerable need for space although not even semiconductor components are contained therein. However, in the illustrated solution, a separate alternating current busbar is to be provided for each phase, and that busbar is to be electrically insulated from the others. All six alternating current busbars L1 to L6 are also sufficiently mechanically fixed, which can cause problems because of the illustrated spatial configuration.

FIG. 6 thus makes it clear that busbars are typically used for interconnecting preformed coils in a large ring generator. Accordingly generators with a plurality of phases would use a corresponding number of rings of such busbars, namely one per phase. It is thus proposed that a ring generator be constructed to avoid the problem and thus in particular to reduce the number of rings and in that respect also to make better use of the available volume. The solution affords the possibility of managing with two direct current busbars 12 and 14, that is to say with two rings. The phase winding portions can also be implemented by use of preformed coils for the proposed solution. Such preformed coils are suitably fitted in the stator over the corresponding stator poles, like for example the poles 6 in FIG. 2.

The illustrated solution typically uses more parts and in particular more rectifying means. The rectifying means as such however are smaller in structure. Smaller units will thus each transmit less energy. The invention thus provides a favorable possible way of connecting preformed coils in parallel relationship in the stator.

Accordingly, in a generator in which the stator windings are connected in parallel relationship, the proposal is to resolve the volume problem that arises, by virtue of busbars, by the use of a ring rectifier. The ring rectifier could be so designed that the windings are equipped with small rectifiers comprising diodes, thyristors or IGBTs and are connected together to plus and minus by way of bars. The number of rings for such busbars can thereby be minimized to down to two, possibly three, if all windings are connected by way of a ring to a star point. Such a rectifier can be cooled with the generator cooling system if it is mounted on the generator. Depending on the respective design configuration involved, no additional housing or additional cooling system needs to be provided. Accordingly, the proposed solution affords the possibility of integration of the rectifier with the generator. Use of the generator cooling system is made possible and, in that respect, the solution saves space.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A generator of a gearless wind power installation, the generator comprising:
a stator;
a rotor member;
stator windings for generating a plurality of alternating currents;
rectifying means electrically coupled to the stator windings for rectifying the alternating currents; and
a plurality of direct current busbars coupled to the rectifying means and configured to receive the rectified alternating currents.

2. The generator according to claim 1, wherein the generator is a synchronous generator.

3. The generator according to claim 1, wherein the plurality of direct current busbars have an annular configuration and are around at least one of the stator and the rectifying means.

4. The generator according to claim 1, wherein the rectifying means are located in a peripheral portion of the generator.

5. The generator according to claim 1, wherein the rectifying means six rectifiers distributed in a peripheral portion of the generator.

6. The generator according to claim 1, wherein the generator has a nominal power of at least one MW.

7. The generator according to claim 1, wherein the generator is at least one of a gearless generator, a multi-pole generator having at least 48 stator poles, and a 6-phase generator.

8. A ring rectifier for rectifying a plurality of alternating currents generated by a generator, the ring rectifier comprising:
at least three rectifying means for rectifying a respective one of the generated alternating currents; and
a plurality of direct current busbars that are arranged in a ring form around a perimeter of at least one of a stator and rotor of the generator and configured to receive the rectified alternating currents.

9. The ring rectifier according to claim 8, wherein the at least three rectifiers are coupled to and controlled by control lines.

10. A wind power installation comprising:
a pod; and
a generator located in the pod, the generator including:
a stator having a plurality of poles;
stator windings around the plurality of poles, respectively, the stator windings configured to generate a plurality of alternating currents;
a plurality of rectifiers for rectifying a respective one of the generated alternating currents to provide a direct current; and
two direct current busbars coupled to the plurality of rectifiers and configured to receive the direct current.

11. The wind power installation according to claim 10, wherein the plurality of alternating currents are mutually phase-displaced alternating currents.

12. The wind power installation according to claim 10, wherein the two direct current busbars are arranged in a ring.

13. The wind power installation according to claim 10, wherein the two direct current busbars are fixed to the stator.

14. The wind power installation according to claim 10, wherein the plurality of rectifiers are located in an outer portion of the generator and coupled to the two direct current busbars.

15. The generator according to claim 1, wherein the plurality of alternating currents are mutually phase-displaced alternating currents.

16. The generator according to claim 1, wherein the plurality of direct current busbars are two direct current busbars.

17. The generator according to claim 2, wherein the generator is at least one of a separately excited synchronous generator and an external rotor member.

18. The generator according to claim 3, wherein the plurality of direct current busbars are thermally coupled to the stator such that the plurality of direct current busbars and the stator are cooled together with the generator.

19. The generator of claim 5, wherein there are at least six times as many rectifying means as there are direct current busbars.
